(19) United States
(12) Patent Application Publication
(10) Pub. No.: US 2006/0113702 A1
(43) Pub. Date: Jun. 1, 2006

(54) Method and tool for producting hollow molded parts

(76) Inventors: Lutz-Peter Honemann, Damme (DE); Matthias Ostermann, Visbek (DE); Peter Jackisch, Weyhe-Kirchweyhe (DE); Maria Thomas, Muhlen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/519,398

(22) PCT Filed: Jul. 16, 2003
(86) PCT No.: PCT/EP03/07701

§ 371 Date: Jan. 4, 2005

(30) Foreign Application Priority Data
Jul. 26, 2002 (DE) 102 34 014.5

(51) Int. Cl. B29C 45/22

(52) U.S. Cl. 264/240; 425/556; 425/577

(57) ABSTRACT

The invention relates to a method for producing hollow molded bodies in a tool support, comprising the following steps: (i) the initial components used for producing the molded body are poured into a mold (iv) that is provided with a core (v) defining the hollow space of the molded body; (ii) the mold (iv) is opened, die molded body being retained by the core (v); (iii) the molded body is removed from the core (v) by removing the molded body from the core (v) outside the mold (iv).

The invention relates to methods for producing hollow., preferably cylindrical, moldings, preferably with a volume of from 5 cm³ to 300 cm³, in a tool carrier, comprising the steps of
(i) filling the starting components for producing the moldings into a mold (iv) which is preferably provided with release agents and has a core (v) which defines the hollow space of the molding, the mold (iv) preferably having a cover
(ii) opening the mold (iv), the molding being securely held by the core (v),
(iii) removing the molding from the core (v).

The invention also relates to tools for producing hollow molded parts including at least one mold (iv) and at least two cores (v) and (vi), which determine the hollow space of the molded parts. Furthermore, the invention relates to fixed-cycle lines which have the tools according to the invention.

The production of molded parts, for example foamed polyurethanes, in tools which may be arranged in a fixed-cycle line is generally known. It is customary practice for the liquid starting materials for producing the molded parts or the molten thermoplastics to be cast or injected by means of a mixing head or some other metering apparatus into a generally temperature-controlled mold, which is subsequently moved on in a closed state in the fixed-cycle line, so that the next-following mold can be filled. Hollow spaces in the molded parts are usually produced by what are known as cores, generally likewise cylindrical, elongate and possibly contoured protuberances of the cover or more frequently of the base of the mold. Demolding usually takes place by the cover being lifted off, the two parts of the mold which define the lateral surface of the molded part being swung away or pushed away from the molded part and the molded part subsequently being pulled off the core, which usually represents the base plate or part of the base plate of the mold. On account of the sometimes very long reaction times before the molded part is cured to the extent that it can be demolded, there are, in particular, fixed-cycle lines for producing polyurethane moldings by reacting the reactive starting components from a multiplicity of molds arranged one after the other in a circulating manner, in order in this way to match the time taken before the respective tool returns to the mixing head for filling to the reaction time.

It is an object of the present invention to develop methods for producing hollow, preferably cylindrical, moldings, preferably with a volume of from 5 cm³ to 300 cm³, in a tool carrier., comprising the steps of
(i) filling the starting components for producing the moldings into a mold (iv) which is preferably provided with release agents and has a core (v) which defines the hollow space of the molding,
(ii) opening the mold (iv), the molding being securely held by the core (v),
(iii) removing the molding from the core (v),
   and suitable tools and fixed-cycle lines which have higher productivity. In particular, the ejection of molded parts per tool should be increased. This aim is of particular significance, since, owing to their complex fabrication, the tools make up a significant cost factor in the production of the molded parts.

We have found that these objects are achieved by a method in which the molding is removed from the core (v), preferably stripped off, outside the mold (iv). The expression “outside the mold” is to be understood as meaning the space which, when the mold is open, lies outside, i.e. above, below or on the rear side of the side parts of the mold defining the lateral surface of the cylindrical molding.

In particular in the case of hollow cylindrical molded parts, the hollow space of which is formed by a core of the mold, the mechanical loading during removal is very high, since the elastic moldings may be pulled over protuberances of the core. Therefore, it is important specifically in these cases that the molded parts are adequately cured, to avoid damage when pulling the molded part off the core. By the method according to the invention, the actual mold (iv) is emptied at an early time and can consequently be filled again before the molding is removed from the core (v). The demolding from the actual mold (iv) can take place much earlier than the removal of the core (v) from the cylindrical molded part, since the loads during the removal of the outer molded parts are much less than during the removal of the core (v). As stated at the beginning, the core is formed in a way defined by the hollow space to be created in the molding and is correspondingly preferably cylindrical, elongate and possibly contoured. The core is preferably located on the base of the mold, while the filling of the mold (iv) preferably takes place via the cover of the mold.

The core (v), which at least partially defines the hollow space of the moldings, is movably arranged according to the invention and can, according to the invention, be removed from the actual mold (iv), which in particular in the case of cylindrical molded parts comprises at least one, preferably at least two, particularly preferably two, parts, which form at least the contour of the lateral surface of the cylinder, and at least a base and/or cover part, which is arranged lying opposite the core. This represents a significant innovation over the prior art, which describes the core as part of the mold. Even when the mold is opened, the core remains with the molding in the mold and the demolding likewise takes place in the mold. Usually, only the cover and the side parts of the mold are opened, i.e. for example tilted or swung out of the closed position, in order to gain access to the molding and pull the latter off the core. According to the invention, the preferably two parts of the mold which are intended to define the lateral surface of the cylindrical molding, and possibly a cover, are movably mounted in the tool, whereby opening of the mold and simple removal of the core (v) with the molded part is achieved. Preferably, the core (v) with the molded part is removed downward or upward from the mold (iv). Preferably, during the demolding of the molded part with the core (v) from the mold, the cover of the mold (iv) is swung open or pushed open, and is possibly subsequently swung, and the side parts of the mold are removed, preferably pushed away, from the molded part, which is fixed on the core (v), to such an extent that the core with the molded part can preferably be removed downward out of the mold.

The surface of the mold (iv), i.e. the surface which comes into contact with the starting components for producing the molding, is preferably provided with generally known release agents, for example wax- or silicon-based or, in particular, aqueous soap solutions, preferably sprayed in, particularly preferably automatically sprayed in. The application of the release agent takes place after the removal of the molding with the core (v) from the mold and before the filling of the starting components into the mold (iv). When the release agent is being applied, the respective bare core, i.e. without a molding, may be located in the mold. Alternatively, it is possible to provide the core with release agent outside the mold.

In a preferred embodiment., the tool for producing the molded parts has at least two cores (v) and (vi), which are alternately positioned in the mold. Consequently, as soon as the molded part in the mold (iv) has cured to the extent that it can be removed together with the one core (v) from the mold, the other core (vi), from which the molded part produced in the previous cycle is removed, preferably in parallel with the removal of the core (v) together with the molded part from the mold (iv), is placed in the mold (iv), which then, in the next step, is filled once again with the starting components for producing a further molded part. That is to say, the removal of the one core (v) with the new molded part from the mold (iv) will preferably be accompanied by stripping of the molded part located on the core (vi), followed by pivoting of the cores (v) and (vi) through 180°, consequently exchanging them in their position, and subsequently introduction of the core (vi) into the mold (iv). In this preferred embodiment, the tool consequently has at least two cores (v) and (vi), which are surrounded with the starting components for producing the moldings at different times in the mold (iv), i.e. are preferably alternately positioned in the mold (iv) for producing the moldings. The cores (v) and (vi) are preferably connected to each other in such a way, for example by means of a common turntable or pivoting beam, that the changing of the cores can take place by lowering the apparatus on which the cores (v) and (vi) are attached out of the mold (iv), subsequent pivoting through 180°, followed by raising of the cores, with the core (vi) being placed in the mold. The cores (v) and (vi) are consequently preferably connected directly to each other. In this case, each tool may also have more than one mold (iv), and correspondingly also more than one core (v), and possibly and preferably more than one core (vi). For example, two molds may be arranged next to each other in the tool.

The tool, in this document also referred to as a tool carrier, consequently preferably has at least two, preferably two, cores (v) and (vi), which are preferably both arranged movably in relation to the mold and can be alternately introduced into the mold (iv). Particularly preferably, the tool has one to four cores (v), one to four cores (vi) and one to four molds (iv), the number of (iv), (v) and (vi) particularly preferably being equal.

Consequently, the production of the moldings in the way according to the invention preferably takes place by the starting components for producing the moldings being filled into a mold (iv) which is provided with release agents and which has a core (v) which is attached to the base or to the cover, preferably to the base, defines the hollow space of the molding and is connected to at least one further core (vi), which is located outside the mold (iv), the mold (iv) being closed, after opening of the mold (iv) the core (V) being moved preferably upward or downward, preferably downward, out of the mold (iv) defined by the outer walls, the core (v) being exchanged for the core (vi), which is not holding a molding, by a pivoting movement through 180°, the core (vi) being moved into the mold (iv), with the core (v) being brought into a position from which the moldings are stripped off the core (v), connected to the core (vi), when the core (vi) is removed from the mold (iv). The stripping may preferably take place in such a way that, during raising of the cores (v) and (vi), i.e. during raising of the core (vi) into the mold (iv), the core (v) with the molding is brought above an only upwardly movable flap or grab, which has a recess for the core, which, although it allows a free movement of the core (v) upward or downward, strips the molding off the core (v) when the cores (v) and (vi) are next lowered on account of the clearance being too small for the molding. This stripping is much less harmful for the moldings than pulling the moldings off the core, for example with automated gripping arms. This preferred stripping has the desired effect of reducing the proportion of defective products.

The moldings produced by the method according to the invention may consist of generally known materials, which can be prepared from liquid, softened or pulverized starting components in a mold. They are preferably elastic moldings. Particularly preferably, the moldings are based on thermoplastic materials, rubber and/or plastics produced from reactive starting components. Particularly preferred are moldings based on cellular polyurethane elastomers, which may possibly contain urea groups. Particularly preferably, the moldings are cellular polyurethane elastomers with a density according to DIN 53 420 of from 200 to 1100, preferably 300 to 800 kg/m3, a tensile strength according to DIN 53 571 of ≧2, preferably 2 to 8 N/mm2, an elongation according to DIN 53 571 of ≧300, preferably 300 to 700% and a tear propagation resistance according to DIN 53 515 of ≧8, preferably 8 to 25 N/mm. The elastomers are preferably microcellular elastomers based on polyisocyanate polyaddition products, preferably having cells with a diameter of from 0.01 mm to 0.5 mm, particularly preferably 0.01 to 0.15 mm.

Elastomers based on polyisocyanate polyaddition products and their preparation are generally known and variously described, for example in EP-A 62 835, EP-A 36 994, EP-A 250 969, DE-A 195 48 770 and DE-A 195 48 771. The cellular polyisocyanate polyaddition products preferably have a compression set of less than 25% according to DIN 53 572, cubes measuring 40 mm×40 mm×30 mm without silicone coating preferably being used as test pieces, the test taking place under constant deformation, the test pieces being compressed by 40% and kept for 22 hours at 80° C. in a circulating air cabinet, the test device being cooled to room temperature after removal from the hot cabinet for 2 hours in the compressed state, the test pieces subsequently being removed from the test device and, 10 min±30 s after removal of the test pieces from the test device, the height of the test pieces being measured to an accuracy of within 0.1 mm. The starting components for producing the moldings consequently preferably constitute a reaction mixture containing (a) isocyanates and (b) compounds reactive to isocyanates, with which mixture cellular polyurethane elastomers are produced as moldings. The preparation of the polyisocyanate polyaddition products may take place by generally known methods, for example by using the following starting substances in a one- or two-stage process:
(a) isocyanate,
(b) compounds reactive to isocyanates,
(c) water and possibly
(d) catalysts,
(e) blowing agents and/or
(f) auxiliaries and/or additives, for example polysiloxanes and/or fatty acid sulfonates.

The surface temperature of the inner mold wall is usually 40 to 95° C., preferably 50 to 90° C. The production of the molded parts is preferably carried out with an NCO/OH ratio of from 0.85 to 1.20, with the heated starting components being mixed and introduced into the preferably heated, preferably tightly closing mold (iv) in an amount corresponding to the desired density of the molded part. The molded parts are cured, and consequently can be demolded, after 1 to 60 minutes. The amount of the reaction mixture introduced into the mold (iv) is usually set such that the moldings obtained have the density already described. The starting components are usually introduced into the molding tool at a temperature of from 15 to 120° C., preferably from 30 to 110° C. The degrees of compaction for producing the moldings lie between 1.1 and 8, preferably between 2 and 6. According to a particularly advantageous embodiment, a prepolymer containing NCO groups is initially prepared in a two-stage process. For this purpose, the component (b) is made to react with (a) in excess, usually at temperatures of from 80° C. to 160° C., preferably from 110° C. to 150° C. The reaction time is set appropriately for reaching the theoretical NCO content. Accordingly, the production of the moldings in a way according to the invention preferably takes place in a two-stage method, in that, in the first stage, a prepolymer having isocyanate groups is prepared by reacting (a) with (b) and, in the second stage, this prepolymer is reacted in a mold with a crosslinking component, possibly containing the further components described at the beginning. The starting components (a) to (f) are described for example at length in the documents DE-A 195 48 770 and DE-A 195 48 771 and, moreover, are generally known to a person skilled in the art.

The method according to the invention preferably takes place continuously, particularly preferably in a fully automated manner, in a fixed-cycle line which comprises at least 4, preferably 30 to 300, particularly preferably 50 to 200 tools. In this fixed-cycle line, the individual tools are usually processed at the following stations:
mold filling station, possibly with a number of mixing heads
mold closing station, in which the filled molds or mold cavities are usually provided with a covering element to achieve uniform curing of the molded parts produced,
curing region feeder for possibly a number of adjacently arranged
curing regions, which are usually heatable, as are preferably also the molds,
mold opening station, in which the molds or covers are opened,
demolding station, in which the cured molded-part blanks on the core (v) are removed from the respective mold and where preferably the molding is at the same time stripped off the core (vi), particularly preferably with directly subsequent exchange of the cores, the core (vi) being placed in the mold after the stripping off of the molding, and the core (v) with the new molding moving into the position for stripping off the molding,
possibly quality control and/or finishing station for the molding or moldings on the core(s) (v) removed from the mold,
cleaning zone, in which the molding tools are cleaned, possibly freed of remains of material and then provided with a release agent before they are conveyed back to the
filling station 4, where the mold or the molds (iv) are once again filled.

Particularly preferably, the molding is removed from the core (v) 1 min to 60 min after the opening of the mold (iv), and consequently the removal of the core (v) from the mold (iv).

The fixing of the produced moldings on the core (v) outside the mold, i.e. with the outer surface of the moldings freely accessible, also offers the major advantage that automated quality control can be carried out without the period to the next filling of the mold having to be extended. The quality control may take place, for example, by generally known optical methods. Preferably, the molding is consequently subjected to a setpoint/actual comparison outside the mold (iv) before the removal of the core (v); Preferably, sorting of the moldings produced, i.e. segregation of defective products, is combined with the quality control. A further advantage of this fixing of the moldings on the core outside the mold is the possibility of subsequently treating the moldings, for example by carrying out processing operations on the molding outside the mold (iv) before removal from the core (v), for example deflashing, engraving, polishing and/or combining with other molded parts, for example rings, caps or inserts, for example by clipping in, slipping over and/or clamping in and/or together.

The invention consequently also relates to a mold carrier for producing hollow molded parts including at least one mold (iv) and at least two cores (v) and (vi), which determine the hollow space of the molded parts, it being possible for the cores (v) and (vi) to be alternately positioned in the mold (iv). In this case, the preferably cylindrical cores (v) and (vi) are preferably arranged such that they are aligned in parallel and movable parallel to the longitudinal axis of the cores, i.e. the cores can be moved upward and/or downward out of the mold (iv). Particularly preferably, the cores (v) and (vi) are pivotably mounted, the common pivot axis lying parallel to the longitudinal axis of the cores and centrally between the cores (v) and (vi). For example, the cores (v) and (vi) may be mounted on a common turntable or a pivotable beam or bar, the distance of the core (v) and the distance of the core (vi) respectively from the pivot axis being the same. Preferred is a tool carrier which includes, enclosing a mold (iv), preferably two side parts, which define at least the lateral surface of the molding to be produced, at least one, preferably a cover part and a base part, which centrally has a core (v) which protrudes into the mold, defines the hollow space of the molding to be produced, is arranged movably downward out of the mold (iv) and is connected to a further core (vi) pivotably about a pivot axis, which is parallel to the longitudinal axis of the cores (v) and (vi) and also of the cylindrical molding, and also preferably a device for stripping the molding off the core (v).

Preferably, the tool carrier includes a device, preferably a flap, with which the moldings are stripped off the core (v). As already described, the tool carrier is preferably arranged movably in a fixed-cycle line, which is preferably circulating and operated continuously, with a mixing head fixed in place in relation to the tool carrier for filling the starting components for producing the moldings into the mold (iv).

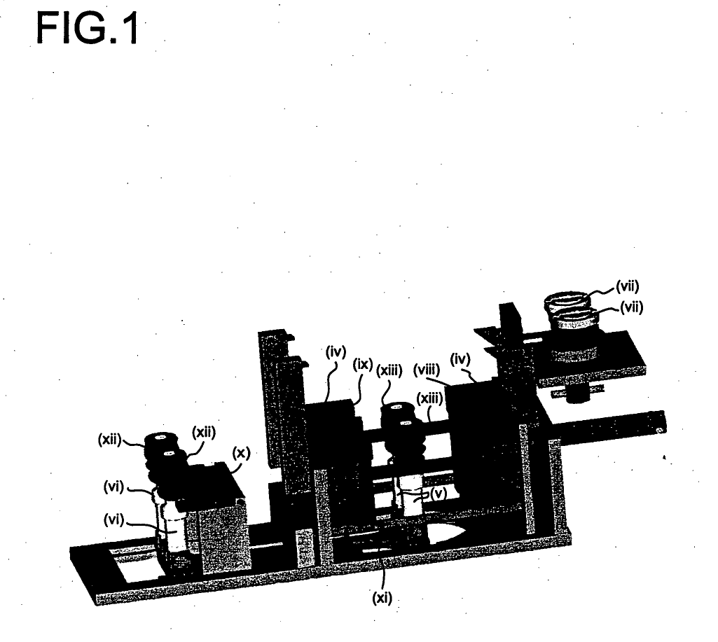

A tool according to the invention, by way of example, is represented in various working stages in FIGS. 1 to 4. In the figures, a tool carrier with two molds (iv) and in each case two cores (v) and (vi) is represented in four stages of the method. The covers of the molds (iv) are identified by (vii), the two side parts of a mold (iv) are respectively identified by (viii) and (ix). The flap for stripping a molded part off the core is denoted by (x). The turntable or pivoting beam is identified by (xi).

In FIG. 1, the mold is open, i.e. the cover has been swung open and the side parts pushed away from the molded part. The molded parts (xii) produced in the mold (iv) in the previous operation and located on the cores (vi) are located above the stripper (x), the new molded parts (xiii) on the cores (v) are still in the old (iv).

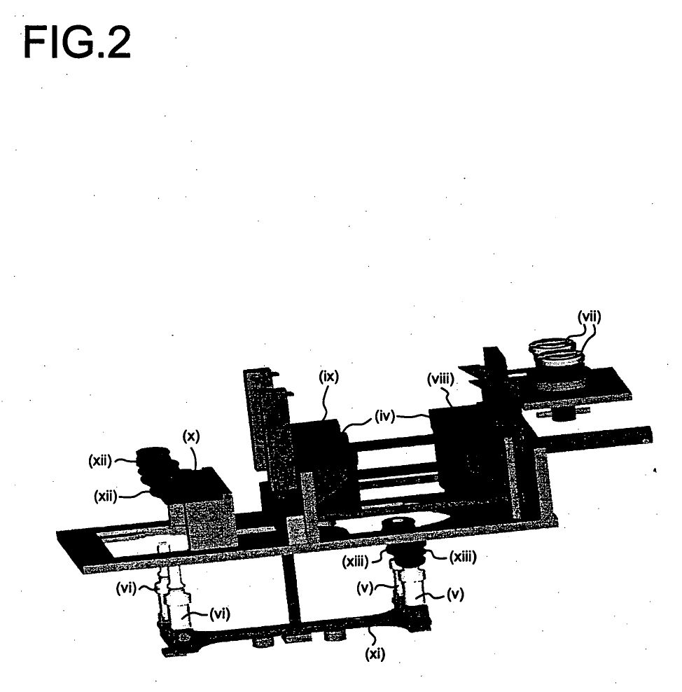

FIG. 2 represents the situation after the pivoting beam (xi) with the cores (v) and (vi) and also the molded parts (xiii) has been lowered out of the mold. The flap (x) has stripped the molded parts (xii) off the cores (vi).

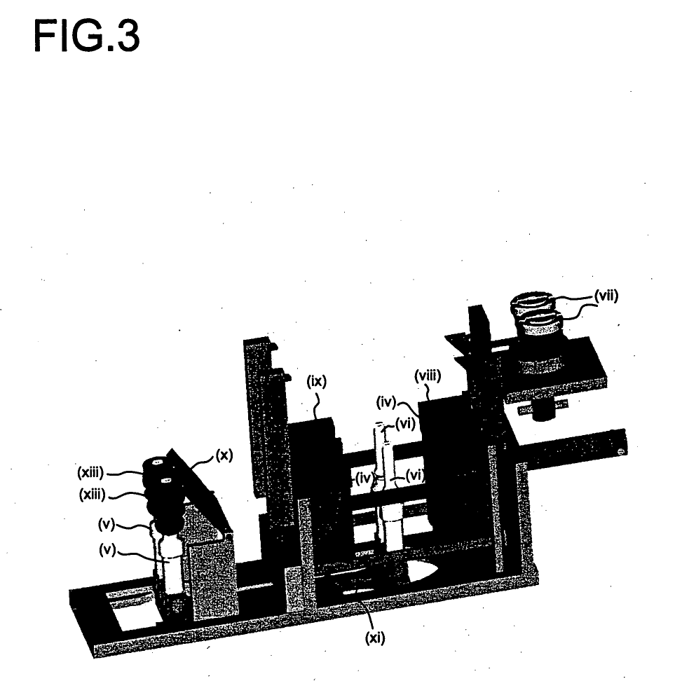

In FIG. 3, after pivoting of the beam (xi) through 180° and raising of the cores (v) and (vi) and of the beam (xi), the cores (vi) are located in the mold (iv) and the cores (v) are located with the new molded parts (xiii) “above” the flap (x).

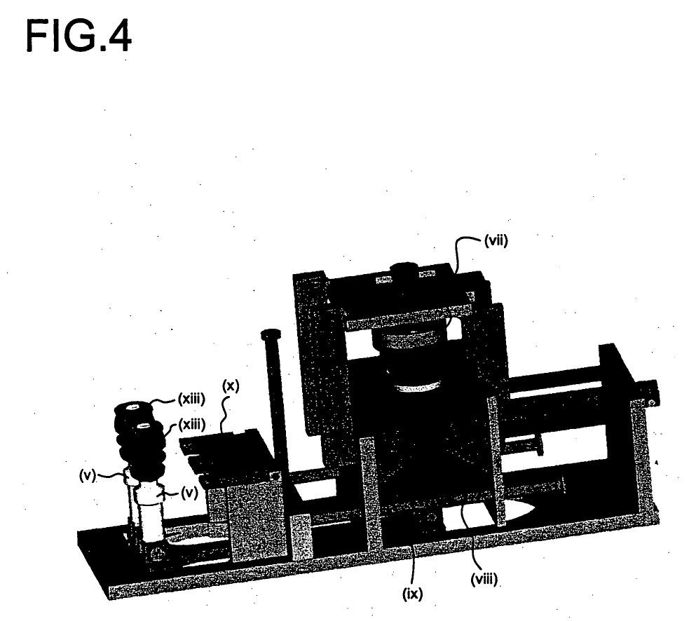

In FIG. 4, the mold (iv) has been closed, in that the side parts (viii) and (ix) have been pushed closed and the covers (vii) have been swung closed. By displacing the side parts (viii), the flap (x) has also been moved away from the cores (v) and the new molded parts (xiii). As a result, the flap (x) has swung down and, when the mold (iv) is opened, is correspondingly pushed again under the molded parts (xiii) (see FIG. 1).

The working step following FIG. 4 can be taken from FIG. 1, i.e. the positions or working steps represented in FIGS. 1 to 4 would preferably be executed continuously.

We claim:

1. A method of producing hollow moldings in a tool carrier, comprising the steps of
(i) filling the starting components for producing the moldings into a mold (iv), which has a core (v) which defines the hollow space of the molding,
(ii) opening the mold (iv), the molding being securely held by the core (v),
(iii) removing the molding from the core (v),
wherein the molding is removed from the core (v) outside the mold (iv).

2. A method as claimed in claim 1, wherein the moldings are produced in a fixed-cycle line comprising at least 4 tool carriers.

3. A method as claimed in claim 1, wherein the tool carrier has at least two cores (v) and (vi), which are alternately introduced into the mold (iv).

4. A method as claimed in claim 1, wherein the starting components for producing the moldings are filled into a mold (iv) which is provided with release agent and which has a core (v) which is attached to the base or to the cover, defines the hollow space of the molding and is connected to at least one further core (vi), which is located outside the mold (iv), the mold (iv) is closed, after opening of the mold (iv) the core (v) is moved downward out of the mold (iv) defined by the outer walls, the core (v) is exchanged for the core (vi), which is not holding a molding, by a pivoting movement through 180°, the core (vi) is moved into the mold (iv), with the core (v) arriving in a position from which the moldings are stripped off the core (v), connected to the core (vi), when the core (vi) is removed from the mold (iv).

5. A method as claimed in claim 1, wherein the moldings are based on thermoplastic materials, rubber and/or plastics produced from reactive starting components in the mold (iv).

6. A method as claimed in claim 1, wherein the starting components for producing the moldings comprise a reaction mixture containing (a) isocyanates and (b) compounds reactive to isocyanates, with which mixture cellular polyurethane elastomers are produced as moldings.

7. A method as claimed in claim 1, wherein the molding is removed from the core (v) 1 min to 60 min after the opening of the mold (iv).

8. A method as claimed in claim 1, wherein the molding is subjected to a setpoint/actual comparison outside the mold (iv) before removal from the core (v).

9. A method as claimed in claim 1, wherein the molding is processed outside the mold (iv) before removal from the core (v).

10. A tool for producing hollow moldings including at least one mold (iv) and at least two cores (v) and (vi), which determine the hollow space of the molded parts, wherein the cores (v) and (vi) can be alternately positioned in the mold (iv).

11. A tool as claimed in claim 10, wherein the cores (v) and (vi) are arranged such that they are aligned in parallel and movable parallel to the longitudinal axis of the cores.

12. A tool as claimed in claim 10, wherein the cores (v) and (vi) are pivotably mounted, the common pivot axis lying parallel to the longitudinal axis of the cores and centrally between the cores (v) and (vi).

13. A tool as claimed in claim 10, wherein the tool has a device with which the molding is stripped off the core (v).

14. A tool as claimed in claim 10, wherein the tool is arranged movably in a fixed-cycle line, which is preferably circulating and operated continuously, with a mixing head fixed in place in relation to the tool for filling the starting components for producing the moldings into the mold (iv).

15. A fixed-cycle line for producing moldings, wherein the fixed-cycle line has at least one tool as claimed in claim 10.
